(19) United States
(12) Patent Application Publication
(10) Pub. No.: US 2025/0065287 A1
(43) Pub. Date: Feb. 27, 2025

(54) Reactor With Monolith Catalyst Blocks For Hydrogen Production

(71) Applicant: Chevron U.S.A. Inc., San Ramon, CA (US)

(72) Inventors: Xiaoying Ouyang, Albany, CA (US); Huping Luo, Moraga, CA (US); Alexander E. Kuperman, Midland, MI (US); Lin Li, San Ramon, CA (US)

(21) Appl. No.: 18/814,252

(22) Filed: Aug. 23, 2024

Related U.S. Application Data
(60) Provisional application No. 63/578,659, filed on Aug. 24, 2023.

(51) Int. Cl. B01J 8/04; B01J 8/06; C01B 3/26

(52) U.S. Cl. CPC B01J 8/0496; B01J 8/0492; B01J 8/067; C01B 3/26; B01J 2208/00407; B01J 2208/065; C01B 2203/085; C01B 2203/1235

(57) ABSTRACT

A reactor uses catalyst blocks for conversion of light hydrocarbons to hydrogen and to liquid hydrocarbons. The catalyst blocks stacked on top of one another within the reactor facilitate conversion of the light hydrocarbons. Electric heaters can be arranged in a variety of orientations within the reactor to supply heat for the conversion reaction. Alternatively, the catalyst blocks can be located within reaction tubes within the reactor and heated by combustion of a fuel adjacent to the reaction tubes. When operated in a regeneration mode, coke that accumulates within the reactor is removed by oxidation.

### CROSS REFERENCE TO RELATED APPLICATIONS

The present application claims the benefit of U.S. Provisional Patent Application No. 63/578,659 filed Aug. 24, 2023, the entire content of which is incorporated herein by reference. The present application also is related to U.S. patent application Ser. No. 17/683,990, filed Mar. 1, 2022, the entire content of which is incorporated herein by reference.

### TECHNICAL FIELD

Embodiments of the technology relate generally to a reactor that includes one or more monolith catalyst blocks for converting light hydrocarbons to hydrogen and liquid hydrocarbons.

### BACKGROUND

Hydrogen is one of the more important options for future clean energy. Light hydrocarbons, such as methane, ethane, and propane, under non-oxidative conditions can produce hydrogen as a clean fuel along with value added chemicals, such as olefins and aromatics. However, existing processes for converting light hydrocarbons to hydrogen usually are not cost-effective because of the energy required for the reaction. The reaction is highly endothermic with enthalpy in the range of about 90 KJ/mol of CH₄ or 60 kJ/mol of H₂. Therefore, to be commercially practical, maintaining a reactor at a temperature range of 600° C. to 1200° C. is required.

In addition to the costs associated with such a heat-intensive reaction, the required heat creates other practical challenges. Under such temperature conditions, the production of coke or solid carbon in the reactor becomes common, which can negatively affect the yield of valuable product and can cause plugging of the reactor. Such high temperatures also can require expensive materials for the reactor and can make design of the reactor challenging.

In view of these challenges, there is a need for solutions that produce hydrogen and value added chemicals from light hydrocarbons in a cost-effective manner. It would further be advantageous if such solutions are more energy efficient that existing approaches to producing hydrogen.

### SUMMARY

In one example embodiment, a reactor for production of hydrogen comprises: (i) a vessel; (ii) a plurality of catalyst stages within the vessel, the plurality of catalyst stages comprising at least a first stage catalyst block and a second stage catalyst block; (iii) at least one electric heater disposed between the first stage catalyst block and the second stage catalyst block; (iv) a feed inlet at a first end of the vessel that provides a feeds comprising C₁-C₃ alkane to the plurality of catalyst stages; (v) a product outlet from which hydrogen and liquid hydrocarbons exit a second end of the vessel, wherein the second end of the vessel is located opposite the first end of the vessel; (vi) an oxidant inlet through which an oxidant enters the vessel and oxidizes coke accumulated within the vessel; and (vii) an exhaust outlet through which exhaust from oxidation of the coke exits the vessel.

In another example embodiment, a process for converting C₁-C₃ alkane comprises: (i) providing at a feed inlet of a vessel a feed comprising the C₁-C₃ alkane to a plurality of catalyst stages disposed within the vessel, the plurality of catalyst stages comprising at least a first stage catalyst block and a second stage catalyst block; (ii) heating the C₁-C₃ alkane to produce hydrogen and liquid C₂-C₁₀ hydrocarbon product, the heating provided by an electric heater disposed between the first stage catalyst block and the second stage catalyst block; (iii) turning off the feed of the C₁-C₃ alkane to the vessel; (iv) providing at an oxidate inlet of the vessel a feed of an oxidate, wherein the oxidate oxidizes coke within the reactor and regenerates the plurality of the catalyst stages; and (v) removing at an exhaust outlet of the vessel an exhaust from oxidation of the coke within the vessel.

In yet another example embodiment, a reactor for production of hydrogen comprises: (i) a vessel; (ii) a plurality of catalyst blocks within the vessel, the plurality of catalyst blocks comprising at least a first catalyst block and a second catalyst block; (iii) at least one electric heater disposed adjacent to at least one of the first catalyst block and the second catalyst block; (iv) a feed inlet at a first end of the vessel that provides a feed comprising C₁-C₃ alkane to the plurality of catalyst blocks; (v) a product outlet from which hydrogen and liquid hydrocarbons exit a second end of the vessel, wherein the second end of the vessel is located opposite the first end of the vessel; (vi) an oxidant inlet through which an oxidant enters the vessel and oxidizes coke accumulated within the vessel; and (vii) an exhaust outlet through which exhaust from oxidation of the coke exits the vessel.

In yet another example embodiment, a process for converting C₁-C₃ alkane comprises: (i) providing at a feed inlet of a vessel a feed comprising the C₁-C₃ alkane to a plurality of catalyst blocks disposed within the vessel, the plurality of catalyst blocks comprising at least a first catalyst block and a second catalyst block; (ii) heating the C₁-C₃ alkane to produce hydrogen and liquid C₂-C₁₀ hydrocarbon product, the heating provided by an electric heater disposed adjacent to at least one of the first catalyst block and the second catalyst block; (iii) turning off the feed of the C₁-C₃ alkane to the vessel; (iv) providing at an oxidate inlet of the vessel a feed of an oxidate, wherein the oxidate oxidizes coke within the reactor and regenerates the plurality of the catalyst stages; and (v) removing at an exhaust outlet of the vessel an exhaust from oxidation of the coke within the vessel.

In yet another example embodiment, a reactor for production of hydrogen comprises: (i) a vessel; (ii) a plurality of reaction tubes within the vessel, the plurality of reaction tubes each housing at least one cracking catalyst block; (iii) a plurality of oxidation tubes within the vessel, the plurality of oxidation tubes each housing at least one oxidation catalyst block; (iv) at least one heater disposed within the vessel; (v) a feed inlet at a first end of the vessel that provides a feed comprising C₁-C₃ alkane to the plurality of reaction tubes; (vi) a product outlet from which hydrogen and liquid hydrocarbons produced from conversion of the C₁-C₃ alkane exit the plurality of reaction tubes at a second end of the vessel, wherein the second end of the vessel is located opposite the first end of the vessel; (vii) an oxidant inlet through which an oxidant enters the plurality of oxidation tubes, wherein heat generated from oxidation within the plurality of oxidation tubes is supplied to the plurality of reaction tubes; and (viii) an exhaust outlet through which exhaust from oxidation within the oxidation tubes exits the vessel.

In yet another example embodiment, a process for converting C₁-C₃ alkane comprises: (i) providing at a feed inlet of a vessel a feed comprising the C₁-C₃ alkane to a plurality of reaction tubes within the vessel, the plurality of reaction tubes each housing at least one cracking catalyst block; (ii) providing at an oxidate inlet of the vessel a feed of an oxidate to a plurality of oxidation tubes within the vessel, the plurality of oxidation tubes each housing at least one oxidation catalyst block; (iii) heating the plurality of reaction tubes causing conversion of the C₁-C₃ alkane to produce hydrogen and liquid C₂-C₁₀ hydrocarbon product, the heating provided by at least one heater disposed within the vessel and by heat from oxidation occurring within the oxidation tubes; (iv) removing the hydrogen and the liquid C₂-C₁₀ hydrocarbon product from the plurality of reaction tubes via a product outlet; and (v) removing at an exhaust outlet of the vessel an exhaust from the oxidation occurring within the oxidation tubes.

In yet another example embodiment, a reactor for production of hydrogen comprises: (i) a vessel; (ii) a plurality of reaction tubes within the vessel, the plurality of reaction tubes each housing at least one catalyst block; (iii) a plurality of burner nozzles disposed within the vessel and outside the plurality of reaction tubes, wherein the plurality of burner nozzles burn a fuel to supply heat to the reaction tubes; (iv) a feed inlet at a first end of the vessel that provides a feed comprising C₁-C₃ alkane to the plurality of reaction tubes; (v) a product outlet from which the hydrogen and liquid hydrocarbons exit a second end of the vessel, wherein the second end of the vessel is located opposite the first end of the vessel; (vi) an oxidant inlet through which an oxidant enters the plurality of reaction tubes and oxidizes coke accumulated within the reaction tubes; and (vii) an exhaust outlet through which exhaust from oxidation of the coke exits the vessel.

In yet another example embodiment, a process for converting C₁-C₃ alkane comprises: (i) providing at a feed inlet of a vessel a feed comprising the C₁-C₃ alkane to a plurality of reaction tubes disposed within the vessel, wherein each reaction tube comprises at least one catalyst block; (ii) heating the C₁-C₃ alkane to produce hydrogen and liquid C₂-C₁₀ hydrocarbon product, the heating provided by combustion at a plurality of burner nozzles disposed within the vessel; (iii) turning off the feed of the C₁-C₃ alkane to the vessel; (iv) providing at an oxidate inlet of the vessel a feed of an oxidate, wherein the oxidate oxidizes coke from the at least one catalyst block within each of the plurality of reaction tubes; and (v) removing at an exhaust outlet of the vessel an exhaust from oxidation of the coke within the vessel.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a reactor with monolith catalyst blocks for producing hydrogen and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates a side cross-sectional view of a reactor for production of hydrogen in accordance with a first example embodiment of the disclosure.

FIG. 2 illustrates a side cross-sectional view of a reactor for production of hydrogen in accordance with a second example embodiment of the disclosure.

FIG. 3 illustrates a side cross-sectional view of a reactor for production of hydrogen in accordance with a third example embodiment of the disclosure.

FIG. 4 illustrates a side cross-sectional view of a reactor for production of hydrogen in accordance with a fourth example embodiment of the disclosure.

FIG. 5A illustrates a side cross-sectional view of a reactor for production of hydrogen in accordance with a fifth example embodiment of the disclosure.

FIG. 5B illustrates a top cross-sectional view of the reactor of FIG. 5A in accordance with the fifth example embodiment of the disclosure.

FIG. 6 illustrates a top cross-sectional view of a reactor for production of hydrogen in accordance with a sixth example embodiment of the disclosure.

FIG. 7 illustrates a side cross-sectional view of a reactor for production of hydrogen in accordance with a seventh example embodiment of the disclosure.

### DETAILED DESCRIPTION OF EXAMPLE EMBODIMENTS

The example embodiments discussed herein are directed to a reactor with monolith catalyst blocks that convert light hydrocarbons, such as C₁-C₃ alkane, into hydrogen and liquid hydrocarbons. Several example embodiments of the reactor are described herein. The example reactors provide improved energy efficiency and provide for a regeneration process to remove coke that accumulates within the reactor and on the catalyst blocks. The arrangement of the catalyst blocks within the reactor is optimized to facilitate the catalytic cracking of the light hydrocarbons as well as the regeneration process. Additionally, the catalyst blocks improve the heat efficiency of the reactor.

In the following paragraphs, particular embodiments will be described in further detail by way of example with reference to the drawings. The embodiments described can be implemented separately, or in combination with other embodiments in the description. In the description, well-known components, methods, and/or processing techniques are omitted or briefly described. Furthermore, reference to various feature(s) of the embodiments is not to suggest that all embodiments must include the referenced feature(s).

### General Process

The example reactors described herein pertain to a process for converting a light hydrocarbon feed comprising primarily C₁-C₃ alkane to a liquid C₂-C₁₀ product and hydrogen. The process generally comprises first flowing the light hydrocarbon feed comprising the C₁-C₃ alkane through monolith catalyst blocks within a reactor vessel. The catalyst blocks facilitate a reaction that converts the C₁-C₃ alkane to the liquid C₂-C₁₀ product and hydrogen. The C₁-C₃ alkane is not particularly limited and may include, for example, natural gas, methane, ethane, propane, or mixtures thereof. As used herein natural gas comprises methane and potentially higher alkanes, carbon dioxide, nitrogen or other gases, and/or sulfide compounds such as hydrogen sulfide, and mixtures thereof. The produced product typically comprises liquid C₂-C₁₀ product and hydrogen. The liquid C₂-C₁₀ product is not particularly limited and could be saturated, unsaturated, aromatic, or a mixture of such compounds. In some embodiments the liquid C₂-C₁₀ product may comprise ethylene, benzene, naphthalene, and various mixtures thereof depending upon the desired products and reactions used.

The C₁-C₃ alkane is usually heated under suitable conditions in the presence of the catalyst to produce the liquid C₂-C₁₀ product and hydrogen. Suitable conditions may vary depending upon the reactants, desired products, catalysts, and equipment employed. Typically, a temperature of from about 500, or from about 700, up to about 1000 or up to about 1200° C., and a pressure of from about 1 atmosphere up to about 3, or up to about 5, or up to about 10, or up to about 20 atmospheres may be employed to produce the liquid C₂-C₁₀ product that may comprise ethylene, acetylene, benzene, naphthalene, or a mixture thereof and hydrogen. In some embodiments, the catalyst blocks are disposed within reaction tubes within the vessel and the C₁-C₃ alkane passing through the catalyst blocks in the reaction tubes is heated by burning a fuel outside the reaction tubes in fuel burning nozzles configured to transfer heat from the burning through the tubes. As described below, the hydrogen produced may be used as the fuel in the fuel burning nozzles outside the tubes.

The monolith catalyst blocks of the embodiments described herein are suitable for light hydrocarbon cracking reactions. The composition, form, size, shape, and properties of the monolith catalyst blocks, also referred to herein more generally as catalyst blocks, may vary depending upon such parameters as the reactants, reactor type, reaction tube size and shape, reaction conditions, and/or desired products. In some embodiments, the monolith catalyst blocks can have a shape that is a rectangular prism, or a cylinder, or a conical shape. The monolith catalyst blocks can comprise one or more holes or channels that increase the surface area and porosity of the catalyst blocks. With adequate porosity and pore structure the effective diffusivity for light hydrocarbons may be in the range of 5×10⁻³ to 2×10⁻² cm²/s, and the catalyst effectiveness factor may be in the range of from 0.05, or from 0.1 up to 0.5, or up to 0.4.

### The Catalyst

The catalyst may comprise washcoated honeycomb monolith catalyst or metal monolith in some embodiments. The monolith may comprise ceramic, silica, quartz, glass, metal, silicon carbide, silicon nitride, boron nitride, a metal oxide or any combination thereof. Suitable metal oxides may comprise alpha-alumina, titania, iron oxide, zirconia, a mixed metal oxide, or any combination thereof.

### Example Reactors

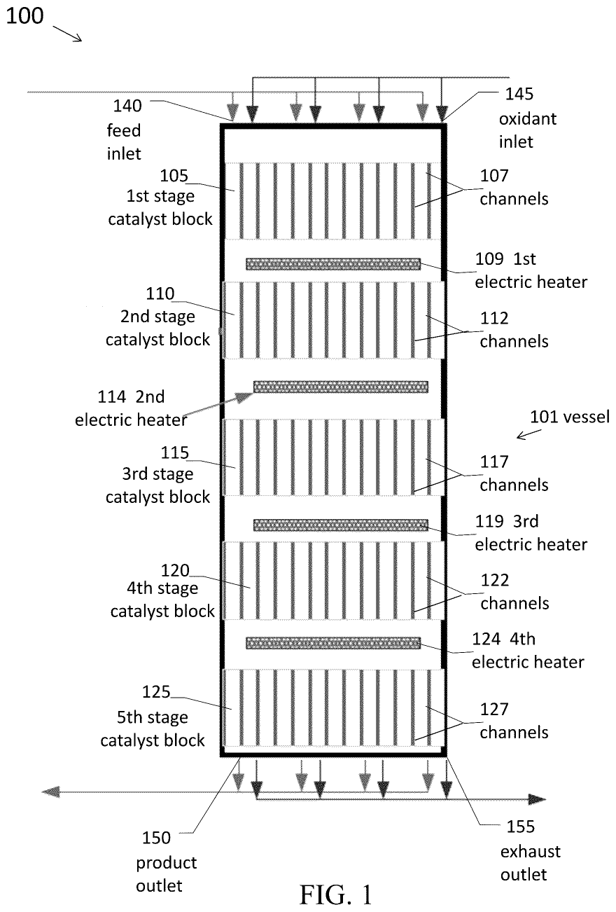

Referring now to the Figures, example embodiments of the reactor will be described. FIG. 1 illustrates a side cross-sectional view of a first example reactor for producing hydrogen in accordance with embodiments of the present disclosure. The reactor 100 of FIG. 1 comprises a cylindrical vessel 101 with a plurality of catalyst stages positioned within the vessel 101. In the example of FIG. 1, there are five catalyst stages—first stage catalyst block 105, second stage catalyst block 110, third stage catalyst block 115, fourth stage catalyst block 120, and fifth stage catalyst block 125. Each catalyst block has channels passing through the block to increase its surface area. Examples of illustrative channels 107, 112, 117, 122, and 127 are shown in each respective catalyst block. The channels can take a variety of shapes and configurations. The example reactor 100 of FIG. 1 also shows an electric heater located between each catalyst block. Specifically, FIG. 1 shows a first electric heater 109, a second electric heater 114, a third electric heater 119, and a fourth electric heater 124. Providing an electric heater between each catalyst block can assist in maintaining a uniform temperature throughout the vessel 101 which can improve the yield of hydrogen and the liquid hydrocarbons produced by the reactor 100. While five catalyst blocks are illustrated with an electric heater disposed between each pair of catalyst blocks, in other embodiments a fewer or greater number of catalyst blocks and heaters can be implemented. Additionally, in other embodiments the shapes of the vessel and the catalyst blocks can have other forms.

FIG. 1 further illustrates a series of feed inlets 140 that supply light hydrocarbons comprising C₁-C₃ alkane at a first end (the top) of the reactor. The C₁-C₃ alkane flows downward through each stage catalyst block and is heated as it flows from one stage catalyst block to the next. As the C₁-C₃ alkane flows downward through the reactor, it is converted to liquid hydrocarbons, such as C₂-C₁₀ product, and hydrogen. The hydrogen and liquid hydrocarbons produced by the reactor exit at a product outlet 150. The product outlet is located at a second end (the bottom) of the vessel, which is located opposite the first end of the vessel. While the reactor is operating in a reaction mode, the C₁-C₃ alkane will flow into the reactor at the feed inlet 140, react within the catalyst blocks producing hydrogen and liquid hydrocarbons, and the products exit the reactor at the product outlet 150.

Due to the high temperatures required for the reaction, coke will accumulate in the reactor requiring that the reactor be operated in a regeneration mode periodically to remove the coke thereby regenerating the catalyst blocks. For purposes of the regeneration mode, the reactor 100 includes an oxidant inlet 145 and an exhaust outlet 155. When operating in the regeneration mode, the supply of C₁-C₃ alkane to the vessel will be turned off and an oxidant such as air, oxygen, or steam, is provided to the vessel 101 at one or more oxidant inlets 145. The oxidant will react with the coke accumulated in the vessel causing the coke to burn off. The exhaust from the oxidation reaction is removed from the vessel 101 at an exhaust outlet 155. An additional benefit of the regeneration mode is that the oxidation reaction produces heat which can be retained by the catalyst blocks and used when the reactor is switched from the regeneration mode back to the reaction mode.

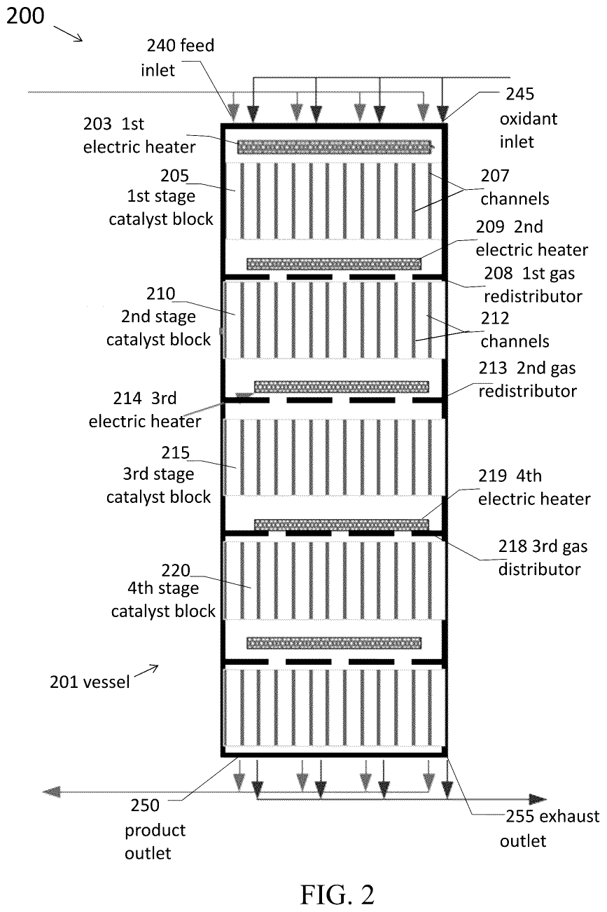

FIGS. 2, 3, and 4 illustrate variations of the embodiment in FIG. 1. Beginning with FIG. 2, a side cross-sectional view is illustrated for a second example reactor for producing hydrogen in accordance with embodiments of the present disclosure. The reactor 200 of FIG. 2 comprises a cylindrical vessel 201 with a plurality of catalyst stages positioned within the vessel 201. In the example of FIG. 2, there are five catalyst stages, which include first stage catalyst block 205, second stage catalyst block 210, third stage catalyst block 215, and fourth stage catalyst block 220. Each catalyst block has channels passing through the block to increase its surface area. Examples of illustrative channels 207 and 212 are shown in the first and second stage catalyst blocks. The channels can take a variety of shapes and configurations. The example reactor 200 of FIG. 2 also shows an electric heater located between each catalyst block and an additional electric heater at the top of the vessel. For example, FIG. 2 shows a first electric heater 203 located above the first stage catalyst block 205, a second electric heater 209, a third electric heater 214, and a fourth electric heater 219. Providing electric heaters interspersed throughout the reactor can assist in maintaining a uniform temperature throughout the vessel 201 which can improve the yield of hydrogen and the liquid hydrocarbons produced by the reactor 200. While five catalyst blocks are illustrated with an electric heater disposed between each pair of catalyst blocks, in other embodiments a fewer or greater number of catalyst blocks and heaters can be implemented. Additionally, in other embodiments the shapes of the vessel and the catalyst blocks can have other forms.

The embodiment of FIG. 2 also illustrates gas redistributors located between the catalyst blocks. For example, reactor 200 includes first gas redistributor 208, second gas redistributor 213, and third gas redistributor 218. The gas redistributors can redistribute the supply of C₁-C₃ alkane throughout the reactor to maintain a consistent reaction and to maintain a uniform temperature throughout the vessel 201. In some examples, the gas redistributors can include a gas feed that supplies new light hydrocarbon comprising C₁-C₃ alkane to the vessel.

Similar to FIG. 1, FIG. 2 further illustrates a series of feed inlets 240 that supply a light hydrocarbon feed comprising C₁-C₃ alkane at a first end (the top) of the reactor. The light hydrocarbon feed comprising the C₁-C₃ alkane flows downward through each stage catalyst block and is heated as it flows from one stage catalyst block to the next. As the C₁-C₃ alkane flows downward through the reactor, it is converted to liquid hydrocarbons, such as C₂-C₁₀ product, and hydrogen. The hydrogen and liquid hydrocarbons produced by the reactor exit at a product outlet 250. While the reactor is operating in a reaction mode, the C₁-C₃ alkane will flow into the reactor at the feed inlet 240, react with the catalyst blocks producing hydrogen and liquid hydrocarbons, and the products exit the reactor at the product outlet 250.

Reactor 200 will be operated in a regeneration mode periodically to remove accumulated coke thereby regenerating the catalyst blocks. When operating in the regeneration mode, the supply of C₁-C₃ alkane to the vessel will be turned off and an oxidant such as air, oxygen, or steam, is provided to the vessel 201 at one or more oxidant inlets 245. The oxidant will react with the coke accumulated in the vessel causing the coke to burn off. The exhaust from the oxidation reaction is removed from the vessel 201 at an exhaust outlet 255. An additional benefit of the regeneration mode is that the oxidation reaction produces heat which can be retained by the catalyst blocks and used when the reactor is switched from the regeneration mode back to the reaction mode.

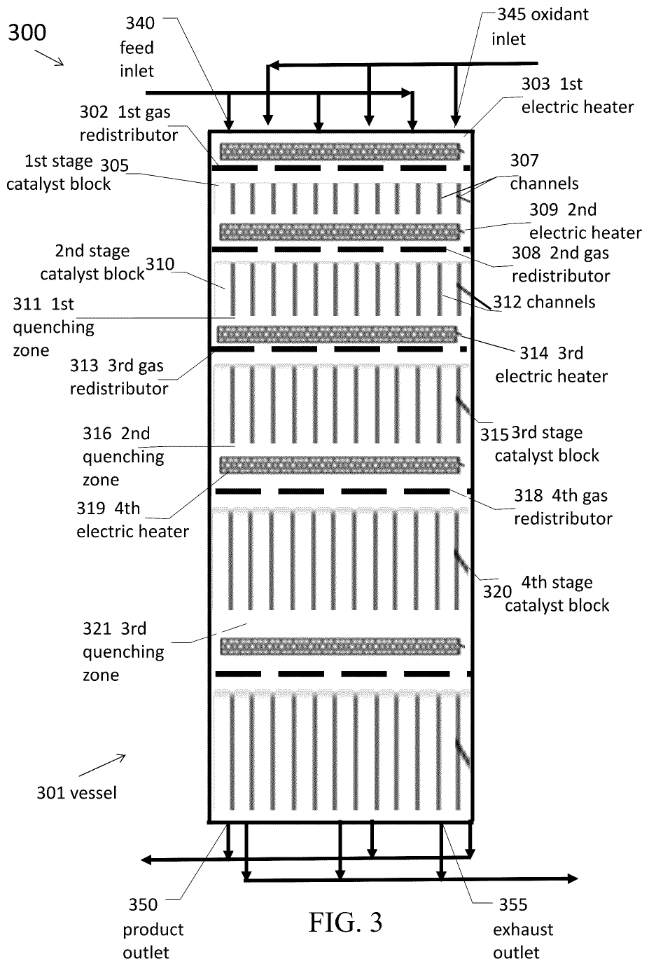

Turning to FIG. 3, a side cross-sectional view is illustrated for a third example reactor for producing hydrogen in accordance with embodiments of the present disclosure. The reactor 300 of FIG. 3 comprises a cylindrical vessel 301 with a plurality of catalyst stages positioned within the vessel 301. In the example of FIG. 3, there are five catalyst stages, which include first stage catalyst block 305, second stage catalyst block 310, third stage catalyst block 315, and fourth stage catalyst block 320. Each catalyst block has channels passing through the block to increase its surface area. Examples of illustrative channels 307 and 312 are shown in the first and second stage catalyst blocks. The channels can take a variety of shapes and configurations. The example reactor 300 of FIG. 3 also shows an electric heater located between each catalyst block and an additional electric heater at the top of the vessel. For example, FIG. 3 shows a first electric heater 303 located above the first stage catalyst block 305, a second electric heater 309, a third electric heater 314, and a fourth electric heater 319. Providing electric heaters interspersed throughout the reactor can assist in maintaining a desired temperature profile along the length of the vessel 301 which can improve the yield of hydrogen and the liquid hydrocarbons produced by the reactor 300. The temperature profile can be further tailored by adjusting the amount of power supplied to each electric heater.

The arrangement of the catalyst blocks in FIG. 3 is unique in that the catalyst blocks have different heights resulting in a non-uniform distribution of the catalyst blocks along the length of the reactor to achieve a particular temperature profile. Temperature control along the length of the reactor is also achieved with quenching zones. In FIG. 3, quenching zones are illustrated between the outlet of certain catalyst blocks and the next electric heater in the progression through the reactor from the top to the bottom of the reactor. As examples, a first quenching zone 311, a second quenching zone 316, and a third quenching zone 321 are illustrated.

The embodiment of FIG. 3 also illustrates gas redistributors interspersed throughout the reactor. For example, reactor 300 includes first gas redistributor 302, second gas redistributor 308, third gas redistributor 313, and fourth gas redistributor 318. The gas redistributors can redistribute the supply of C₁-C₃ alkane throughout the reactor to maintain a consistent reaction and to maintain a desired temperature profile along the vessel 301. Maintaining a lower temperature profile can inhibit the formation of excessive heavier hydrocarbons that can contribute to coke accumulation and clogging of the reactor. In some examples, the gas redistributors can include a gas feed that supplies new light hydrocarbon comprising C₁-C₃ alkane to the vessel and also assists in controlling the temperature profile throughout the vessel 301.

Similar to FIG. 1, FIG. 3 further illustrates a series of feed inlets 340 that supply C₁-C₃ alkane at a first end (the top) of the reactor. The C₁-C₃ alkane flows downward through each stage catalyst block and is heated as it flows from one stage catalyst block to the next. As the C₁-C₃ alkane flows downward through the reactor, it is converted to liquid hydrocarbons, such as C₂-C₁₀ product, and hydrogen. The hydrogen and liquid hydrocarbons produced by the reactor exit at a product outlet 350. While the reactor is operating in a reaction mode, the C₁-C₃ alkane will flow into the reactor at the feed inlet 340, react with the catalyst blocks producing hydrogen and liquid hydrocarbons, and the products exit the reactor at the product outlet 350.

Reactor 300 will be operated in a regeneration mode periodically to remove accumulated coke thereby regenerating the catalyst blocks. When operating in the regeneration mode, the supply of C₁-C₃ alkane to the vessel will be turned off and an oxidant such as air, oxygen, or steam, is provided to the vessel 301 at one or more oxidant inlets 345. The oxidant will react with the coke accumulated in the vessel causing the coke to burn off. The exhaust from the oxidation reaction is removed from the vessel 301 at an exhaust outlet 355. An additional benefit of the regeneration mode is that the oxidation reaction produces heat which can be retained by the catalyst blocks and used when the reactor is switched from the regeneration mode back to the reaction mode.

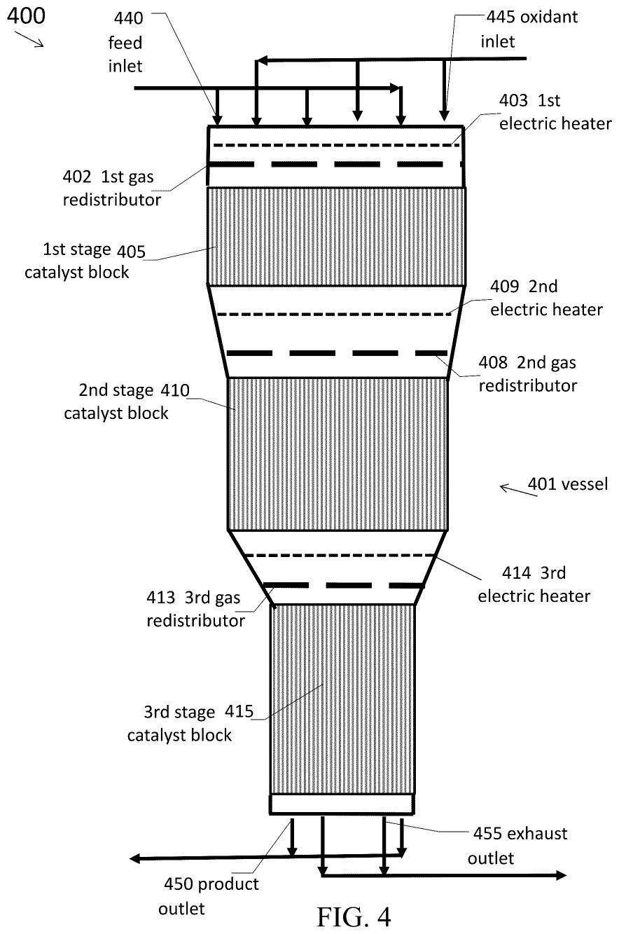

Turning to FIG. 4, a side cross-sectional view is illustrated for a fourth example reactor for producing hydrogen in accordance with embodiments of the present disclosure. The reactor 400 of FIG. 4 comprises a vessel 401 having a tapering shape that is wider at the top and narrower at the bottom. A plurality of catalyst stages are positioned within the vessel 401 with each stage having a progressively smaller diameter across the vessel 401. In the example of FIG. 4, there are three catalyst stages, which include first stage catalyst block 405, second stage catalyst block 410, and a third stage catalyst block 415. Each catalyst block has channels passing through the block to increase its surface area. The channels can take a variety of shapes and configurations. Corresponding with the tapering shape of the vessel 401, each catalyst block has a progressively smaller diameter across the vessel 401 with the widest catalyst block 405 at the first stage and the narrowest catalyst block 415 at the third stage with the flow proceeding from the top to the bottom of each catalyst block as the feed enters the top of the vessel 401 and proceeds through each catalyst block toward the bottom of the vessel 401 as it is converted into the products. The tapering shape of the vessel and the progressively narrower catalyst blocks can be useful for decreasing the residence time of the C₁-C₃ alkane and the products within the vessel to prevent reactions from proceeding for too long and forming excessive heavier hydrocarbons that can contribute to coke accumulation and clogging of the reactor.

The example reactor 400 of FIG. 4 also shows an electric heater located between each catalyst block and an additional electric heater at the top of the vessel. For example, FIG. 4 shows a first electric heater 403 located above the first stage catalyst block 405, a second electric heater 409, and a third electric heater 414. Providing electric heaters interspersed throughout the reactor can assist in maintaining a desired temperature profile along the length of the vessel 401 which can improve the yield of hydrogen and the liquid hydrocarbons produced by the reactor 400. The temperature profile can be further tailored by adjusting the amount of power supplied to each electric heater. While not illustrated in FIG. 4, the vessel 401 also can include quenching zones to control the temperature profile in a manner similar to that described in connection with FIG. 3.

The embodiment of FIG. 4 also illustrates gas redistributors interspersed throughout the reactor. For example, reactor 400 includes first gas redistributor 402, second gas redistributor 408, and third gas redistributor 413. The gas redistributors can redistribute the supply of C₁-C₃ alkane throughout the reactor to maintain a consistent reaction and to maintain a desired temperature profile along the vessel 301. Maintaining a lower temperature profile can inhibit the formation of excessive heavier hydrocarbons that can contribute to coke accumulation and clogging of the reactor. In some examples, the gas redistributors can include a gas feed the supplies new light hydrocarbon comprising C₁-C₃ alkane to the vessel and also assists in controlling the temperature profile throughout the vessel 401.

Similar to FIG. 1, FIG. 4 further illustrates a series of feed inlets 440 that supply light hydrocarbon comprising C₁-C₃ alkane at a first end (the top) of the reactor. The C₁-C₃ alkane flows downward through each stage catalyst block and is heated as it flows from one stage catalyst block to the next. As the C₁-C₃ alkane flows downward through the reactor, it is converted to liquid hydrocarbons, such as C₂-C₁₀ product, and hydrogen. The hydrogen and liquid hydrocarbons produced by the reactor exit at a product outlet 450. While the reactor is operating in a reaction mode, the C₁-C₃ alkane will flow into the reactor at the feed inlet 440, react with the catalyst blocks producing hydrogen and liquid hydrocarbons, and the products exit the reactor at the product outlet 450.

Reactor 400 will be operated in a regeneration mode periodically to remove accumulated coke thereby regenerating the catalyst blocks. When operating in the regeneration mode, the supply of C₁-C₃ alkane to the vessel will be turned off and an oxidant such as air, oxygen, or steam, is provided to the vessel 401 at one or more oxidant inlets 445. The oxidant will react with the coke accumulated in the vessel causing the coke to burn off. The exhaust from the oxidation reaction is removed from the vessel 401 at an exhaust outlet 455. An additional benefit of the regeneration mode is that the oxidation reaction produces heat which can be retained by the catalyst blocks and used when the reactor is switched from the regeneration mode back to the reaction mode.

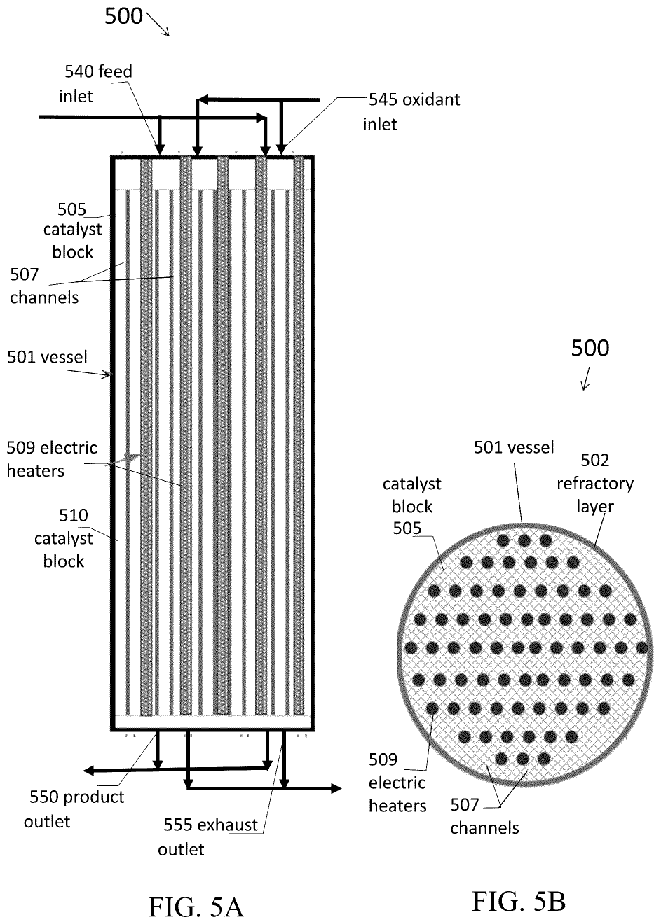

Referring now to FIGS. 5A and 5B, another embodiment of a reactor 500 is illustrated that is a further variation on the reactors illustrated in FIGS. 1-4. FIG. 5A illustrates a side cross-sectional view of reactor 500 and FIG. 5B illustrates a top cross-sectional view of reactor 500. The reactor 500 comprises a cylindrical vessel 501 with catalyst blocks stacked on top of each other. Unlike the embodiments of FIGS. 1-4, the catalyst blocks are not spaced apart with intervening components such as heaters, gas redistributors, or quenching zones. FIG. 5A illustrates a first catalyst block 505 stacked on top of a second catalyst block 510. However, additional catalyst blocks also can be stacked within the vessel 501. The catalyst blocks have channels passing through each block to increase surface area. Examples of illustrative channels 507 are shown passing through the first catalyst block 505 and the second catalyst block 510. The channels can take a variety of shapes and configurations.

A further difference between reactor 500 and the previous examples is the positioning of electric heaters 509 extending vertically from the top to the bottom of the vessel 501 and passing through the catalyst blocks. As illustrated in FIGS. 5A and 5B, a plurality electric heaters 509 can be interspersed throughout the reactor to maintain a desired temperature profile along the length of the vessel 501 and across the diameters of the vessel 501 which can improve the yield of hydrogen and the liquid hydrocarbons produced by the reactor 500. Furthermore, the power supplied to the electrical heaters 509 can be adjusted individually for more precise control of the temperature both along the length and along the diameters within the vessel 501. In order to assist with insulating the vessel and maintaining heat within the vessel, FIG. 5B additionally illustrates that a refractory layer 502 can be placed along the inner surface of the vessel 501, as well as the other example vessels described herein.

Similar to FIG. 1, FIG. 5A further illustrate a series of feed inlets 540 that supply light hydrocarbon comprising C₁-C₃ alkane at a first end (the top) of the reactor. The C₁-C₃ alkane flows downward through each stage catalyst block and is heated as it flows from one stage catalyst block to the next. As the C₁-C₃ alkane flows downward through the reactor, it is converted to liquid hydrocarbons, such as C₂-C₁₀ product, and hydrogen. The hydrogen and liquid hydrocarbons produced by the reactor exit at a product outlet 550. While the reactor is operating in a reaction mode, the C₁-C₃ alkane will flow into the reactor at the feed inlet 540, react with the catalyst blocks producing hydrogen and liquid hydrocarbons, and the products exit the reactor at the product outlet 550.

Reactor 500 will be operated in a regeneration mode periodically to remove accumulated coke thereby regenerating the catalyst blocks. When operating in the regeneration mode, the supply of C₁-C₃ alkane to the vessel will be turned off and an oxidant such as air, oxygen, or steam, is provided to the vessel 501 at one or more oxidant inlets 545. The oxidant will react with the coke accumulated in the vessel causing the coke to burn off. The exhaust from the oxidation reaction is removed from the vessel 501 at an exhaust outlet 555. An additional benefit of the regeneration mode is that the oxidation reaction produces heat which can be retained by the catalyst blocks and used when the reactor is switched from the regeneration mode back to the reaction mode.

In certain examples of reactor 500 (as well as the reactors of FIGS. 1-4), the catalyst blocks can be coated with multiple catalysts, wherein one catalyst is active during the reaction mode and facilitates the conversion of C₁-C₃ alkane to C₂-C₁₀ product and hydrogen, and the other catalyst is active during the regeneration mode and facilitates oxidation of accumulated coke. In yet another variation, in certain example embodiments the catalyst blocks can comprise two types of catalyst blocks, wherein one type of block comprises catalyst for conversion of C₁-C₃ alkane to C₂-C₁₀ product and hydrogen when the reactor is operating in reaction mode, and wherein the other type of block comprises catalyst for oxidation of accumulated coke when the reactor is operating in regeneration mode.

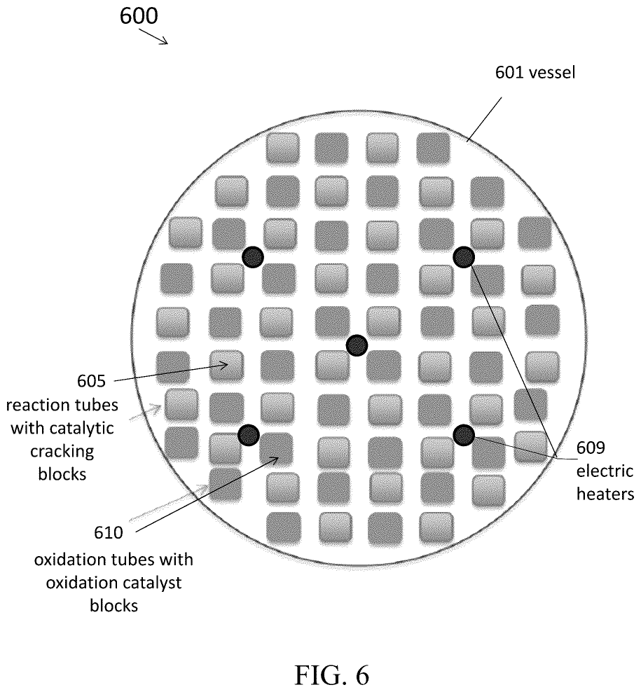

Referring now to FIG. 6, another example embodiment of a reactor 600 is illustrated. FIG. 6 provides a top cross-sectional view of reactor 600. Reactor 600 comprises a cylindrical vessel 601 with a plurality of electric heaters 609 extending vertically from the top to the bottom of the vessel 601 in an arrangement similar to that of FIGS. 5A and 5B. Although not shown in FIG. 6, reactor 600 can include a feed inlet, a product outlet, an oxidant inlet, and an exhaust outlet similar to those previously described.

Reactor 600 differs from the previous examples in that the vessel 601 also contains a plurality of tubes extending vertically from the top to the bottom of the vessel 601. In the example of reactor 600, there are two types of tubes that are intermingled among the plurality of tubes. One type of tubes are reaction tubes 605, each of which contains one or more catalyst blocks coated with a cracking catalyst that facilitates the conversion of C₁-C₃ alkane to C₂-C₁₀ product and hydrogen. The other type of tubes are oxidation tubes 610, each of which contains one or more catalyst blocks coated with an oxidation catalyst that facilitates oxidation of a flue gas or other fuel gas. Because the tubes isolate the C₁-C₃ alkane conversion reaction from the oxidation reaction, the two reactions can occur simultaneously and the heat generated by the oxidation tubes 610 can be absorbed by the reaction tubes 605 to facilitate the C₁-C₃ alkane conversion reaction. With this arrangement, the amount of energy required to heat the reaction tubes in which the C₁-C₃ alkane conversion reaction takes place can be greatly reduced. As one example, if a temperature of 1000° C. is needed for the C₁-C₃ alkane conversion reaction, the oxidation tubes can supply approximately half the required heat such that the electric heaters 609 can be operated at a lower power to supply approximately 500° C.

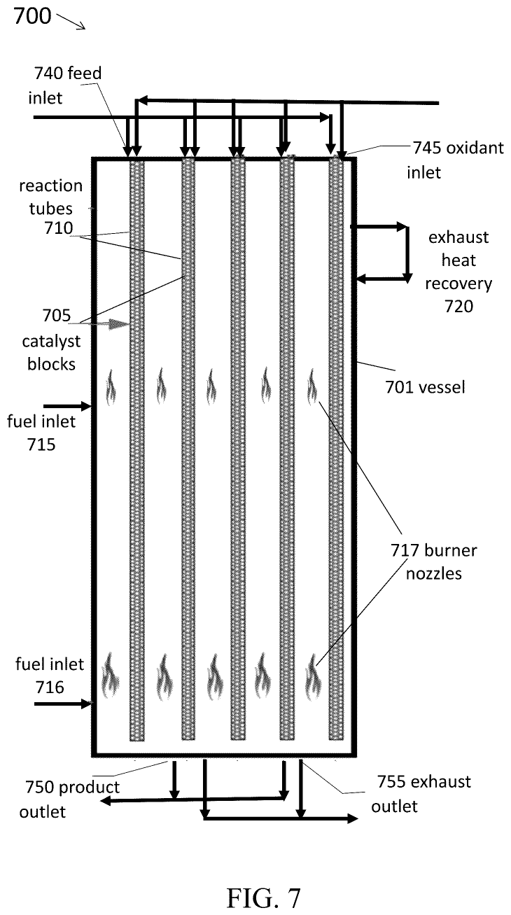

Referring to FIG. 7, a side cross-sectional view of a reactor 700 for production of hydrogen in accordance with a seventh example embodiment of the disclosure is illustrated. Reactor 700 comprises a cylindrical vessel 701 with reaction tubes 710 extending vertically from the top to the bottom of the vessel 701. Each of the reaction tubes 710 contains one or more catalyst blocks coated with a cracking catalyst that facilitates the conversion of C₁-C₃ alkane to C₂-C₁₀ product and hydrogen.

Similar to several of the previous embodiments, FIG. 7 illustrates a series of feed inlets 740 that supply C₁-C₃ alkane to the catalyst blocks 705 within the reaction tubes 710 at a first end (the top) of the reactor. The C₁-C₃ alkane flows downward through the catalyst blocks and is heated. As the C₁-C₃ alkane flows through the reactor and is heated, it is converted to liquid hydrocarbons, such as C₂-C₁₀ product, and hydrogen. The hydrogen and liquid hydrocarbons produced by the reactor exit at a product outlet 750. While the reactor 700 is operating in a reaction mode, the C₁-C₃ alkane will flow into the reactor at the feed inlet 740, react with the catalyst blocks producing hydrogen and liquid hydrocarbons, and the products exit the reactor at the product outlet 750.

Reactor 700 will be operated in a regeneration mode periodically to remove accumulated coke thereby regenerating the catalyst blocks. When operating in the regeneration mode, the supply of C₁-C₃ alkane to the reaction tubes 710 will be turned off and an oxidant such as air, oxygen, or steam, is provided to the reaction tubes 710 via one or more oxidant inlets 745. The oxidant will react with the coke accumulated in the vessel causing the coke to burn off. The exhaust from the oxidation reaction is removed from the vessel 701 at an exhaust outlet 755. An additional benefit of the regeneration mode is that the oxidation reaction produces heat which can be retained by the catalyst blocks and used when the reactor is switched from the regeneration mode back to the reaction mode.

When the reactor 700 is operating in reaction mode, heat is supplied to the reaction tubes 710 by burner nozzles 717 outside and along the length of the plurality of reaction tubes 710. The burner nozzles 717 burn a fuel and can be distributed throughout the reactor to provide uniform heating and can be individually controlled to achieve a desired temperature profile along the length and the diameters of the vessel 701. The fuel, supplied by fuel inlets 715 and 716, is not particularly critical so long as it is capable of heating the tubes adequately. In some embodiments the fuel comprises a hydrocarbon, hydrogen, or a mixture thereof. In some embodiments the fuel may comprise hydrogen formed in the process. In some embodiments at least a portion of the heat used in heating the C₁-C₃ alkane in the reaction tubes comprises heat from an exhaust heat recovery 720 that recovers heat from the exhaust of the burner nozzles 717.

Like the catalyst blocks, the reaction tubes in the reactor may vary in shape, size, material, and/or properties depending upon such parameters as the reactants, reactor type, reaction conditions, and/or desired products. The plurality of reaction tubes may comprise a ceramic, a metal, or a mixture thereof. Suitable metals may include, for example, alloy 800, alloy 800/HT, alloy 309, any other metallurgy suitable for high temperature services, or a mixture thereof.

In some embodiments the reaction tubes are configured to minimize or lessen pressure drop. For example, the reaction tubes may be configured such that a pressure drop within the plurality of reaction tubes comprises less than about 45 psig.

If desired the plurality of reaction tubes may comprise one or metal inserts within the plurality of reaction tubes to facilitate the transfer of heat in a radial direction within the plurality of reaction tubes. The metal insert may comprise a screen, a plate, or a combination thereof.

In this manner the effective thermal conductivity in a radial direction may be from about 5 to about 200 W/mK while the temperature drop may be less than 50 to 200° C. The plurality of reaction tubes may also be configured such that the heating duty per tube is from about 2 kW/m² tube to about 70 kW/m²-tube. The size of the reaction tubes may vary depending upon the desired heat transfer and other properties of the system. In some embodiments, a majority of the plurality of reaction tubes within the vessel have a diameter of from about 1, or from about 2 up to about 6, or up to about 7 inches. In some embodiments, one or more of the plurality of reaction tubes within the vessel may have a diameter of from about 1, or from about 2 up to about 6, or up to about 7 inches.

### EXAMPLE EMBODIMENTS

The following are further non-limiting example embodiments.

EE1. A reactor for production of hydrogen, the reactor comprising:
a vessel;
a plurality of catalyst stages within the vessel, the plurality of catalyst stages comprising at least a first stage catalyst block and a second stage catalyst block;
at least one electric heater disposed between the first stage catalyst block and the second stage catalyst block;
a feed inlet at a first end of the vessel that provides a feed comprising C₁-C₃ alkane to the plurality of catalyst stages;
a product outlet from which hydrogen and liquid hydrocarbons exit a second end of the vessel, wherein the second end of the vessel is located opposite the first end of the vessel;
an oxidant inlet through which an oxidant enters the vessel and oxidizes coke accumulated within the vessel; and
an exhaust outlet through which exhaust from oxidation of the coke exits the vessel.

EE2. The reactor of EE1, further comprising a gas redistributor disposed between the first stage catalyst block and the second stage catalyst block.

EE3. The reactor of any previous example embodiment, further comprising a quenching zone disposed between the first stage catalyst block and the at least one electric heater.

EE4. The reactor of any previous example embodiment, wherein the second stage catalyst block is larger than the first stage catalyst block.

EE5. The reactor of any previous example embodiment, wherein the second stage catalyst block has a smaller diameter than the first stage catalyst block.

EE6. A process for converting C₁-C₃ alkane, the process comprising:
providing at a feed inlet of a vessel a feed comprising the C₁-C₃ alkane to a plurality of catalyst stages disposed within the vessel, the plurality of catalyst stages comprising at least a first stage catalyst block and a second stage catalyst block;
heating the C₁-C₃ alkane to produce hydrogen and liquid C₂-C₁₀ hydrocarbon product, the heating provided by an electric heater disposed between the first stage catalyst block and the second stage catalyst block;
turning off the feed of the C₁-C₃ alkane to the vessel;
providing at an oxidate inlet of the vessel a feed of an oxidate, wherein the oxidate oxidizes coke within the reactor and regenerates the plurality of the catalyst stages; and
removing at an exhaust outlet of the vessel an exhaust from oxidation of the coke within the vessel.

EE7. The process of EE6, further comprising redistributing the C₁-C₃ alkane between the first stage catalyst block and the second stage catalyst block.

EE8. The process of any previous example embodiment, further comprising cooling the hydrogen and the liquid C₂-C₁₀ hydrocarbon product in a quenching zone between the first stage catalyst block and the second stage catalyst block.

EE9. The process of any previous example embodiment, wherein the second stage catalyst block is larger than the first stage catalyst block.

EE10. The process of any previous example embodiment, wherein the second stage catalyst block as a smaller diameter than the first stage catalyst block.

EE11. A reactor for production of hydrogen, the reactor comprising:
a vessel;
a plurality of catalyst blocks within the vessel, the plurality of catalyst blocks comprising at least a first catalyst block and a second catalyst block;
at least one electric heater disposed adjacent to at least one of the first catalyst block and the second catalyst block;
a feed inlet at a first end of the vessel that provides a feed comprising C1-C3 alkane to the plurality of catalyst blocks;
a product outlet from which hydrogen and liquid hydrocarbons exit a second end of the vessel, wherein the second end of the vessel is located opposite the first end of the vessel;
an oxidant inlet through which an oxidant enters the vessel and oxidizes coke accumulated within the vessel; and
an exhaust outlet through which exhaust from oxidation of the coke exits the vessel.

EE12. The reactor of EE11, wherein the at least one electric heater passes through at least one of the first catalyst block and the second catalyst block.

EE13. The reactor of any previous example embodiment, wherein the at least one electric heater comprises a plurality of electric heaters passing through the first catalyst block and the second catalyst block.

EE14. A process for converting C1-C3 alkane, the process comprising:
providing at a feed inlet of a vessel a feed comprising the C1-C3 alkane to a plurality of catalyst blocks disposed within the vessel, the plurality of catalyst blocks comprising at least a first catalyst block and a second catalyst block;
heating the C1-C3 alkane to produce hydrogen and liquid C2-C10 hydrocarbon product, the heating provided by an electric heater disposed adjacent to at least one of the first catalyst block and the second catalyst block;
turning off the feed of the C1-C3 alkane to the vessel;
providing at an oxidate inlet of the vessel a feed of an oxidate, wherein the oxidate oxidizes coke within the reactor and regenerates the plurality of the catalyst stages; and
removing at an exhaust outlet of the vessel an exhaust from oxidation of the coke within the vessel.

EE15. The process of EE14, wherein the at least one electric heater passes through at least one of the first catalyst block and the second catalyst block.

EE16. The process of any previous example embodiment, wherein the at least one electric heater comprises a plurality of electric heaters passing through the first catalyst block and the second catalyst block.

EE17. A reactor for production of hydrogen, the reactor comprising:
a vessel;
a plurality of reaction tubes within the vessel, the plurality of reaction tubes each housing at least one cracking catalyst block;
a plurality of oxidation tubes within the vessel, the plurality of oxidation tubes each housing at least one oxidation catalyst block;
at least one heater disposed within the vessel;
a feed inlet at a first end of the vessel that provides a feed comprising C1-C3 alkane to the plurality of reaction tubes;
a product outlet from which hydrogen and liquid hydrocarbons produced from conversion of the C1-C3 alkane exit the plurality of reaction tubes at a second end of the vessel, wherein the second end of the vessel is located opposite the first end of the vessel;
an oxidant inlet through which an oxidant enters the plurality of oxidation tubes, wherein heat generated from oxidation within the plurality of oxidation tubes is supplied to the plurality of reaction tubes; and
an exhaust outlet through which exhaust from oxidation within the oxidation tubes exits the vessel.

EE18. The reactor of EE17, wherein the conversion of the C1-C3 alkane in the plurality of reaction tubes occurs simultaneously with the oxidation in the plurality of oxidation tubes.

EE19. A process for converting C1-C3 alkane, the process comprising:
providing at a feed inlet of a vessel a feed comprising the C1-C3 alkane to a plurality of reaction tubes within the vessel, the plurality of reaction tubes each housing at least one cracking catalyst block;
providing at an oxidate inlet of the vessel a feed of an oxidate to a plurality of oxidation tubes within the vessel, the plurality of oxidation tubes each housing at least one oxidation catalyst block;
heating the plurality of reaction tubes causing conversion of the C1-C3 alkane to produce hydrogen and liquid C2-C10 hydrocarbon product, the heating provided by at least one heater disposed within the vessel and by heat from oxidation occurring within the oxidation tubes;
removing the hydrogen and the liquid C2-C10 hydrocarbon product from the plurality of reaction tubes via a product outlet; and
removing at an exhaust outlet of the vessel an exhaust from the oxidation occurring within the oxidation tubes.

EE20. The process of EE19, wherein the conversion of the C1-C3 alkane in the plurality of reaction tubes occurs simultaneously with the oxidation in the plurality of oxidation tubes.

EE21. A reactor for production of hydrogen, the reactor comprising:
a vessel;
a plurality of reaction tubes within the vessel, the plurality of reaction tubes each housing at least one catalyst block;
a plurality of burner nozzles disposed within the vessel and outside the plurality of reaction tubes, wherein the plurality of burner nozzles burn a fuel to supply heat to the reaction tubes;
a feed inlet at a first end of the vessel that provides a feed comprising C1-C3 alkane to the plurality of reaction tubes;
a product outlet from which the hydrogen and liquid hydrocarbons exit a second end of the vessel, wherein the second end of the vessel is located opposite the first end of the vessel;
an oxidant inlet through which an oxidant enters the plurality of reaction tubes and oxidizes coke accumulated within the reaction tubes; and
an exhaust outlet through which exhaust from oxidation of the coke exits the vessel.

EE22. The reactor of EE21, wherein heat recovered from burner exhaust generated by the plurality of burner nozzles is recovered and used to heat the plurality of reaction tubes.

EE23. A process for converting C1-C3 alkane, the process comprising:
providing at a feed inlet of a vessel a feed comprising the C1-C3 alkane to a plurality of reaction tubes disposed within the vessel, wherein each reaction tube comprises at least one catalyst block;
heating the C1-C3 alkane to produce hydrogen and liquid C2-C10 hydrocarbon product, the heating provided by combustion at a plurality of burner nozzles disposed within the vessel;
turning off the feed of the C1-C3 alkane to the vessel;
providing at an oxidate inlet of the vessel a feed of an oxidate, wherein the oxidate oxidizes coke from the at least one catalyst block within each of the plurality of reaction tubes; and
removing at an exhaust outlet of the vessel an exhaust from oxidation of the coke within the vessel.

For any figure shown and described herein, one or more of the components may be omitted, added, repeated, and/or substituted. Additionally, it should be understood that in certain cases components of the example systems can be combined or can be separated into subcomponents. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A reactor for production of hydrogen, the reactor comprising:
a vessel;
a plurality of catalyst stages within the vessel, the plurality of catalyst stages comprising at least a first stage catalyst block and a second stage catalyst block;
at least one electric heater disposed between the first stage catalyst block and the second stage catalyst block;
a feed inlet at a first end of the vessel that provides a feed comprising C₁-C₃ alkane to the plurality of catalyst stages;
a product outlet from which hydrogen and liquid hydrocarbons exit a second end of the vessel, wherein the second end of the vessel is located opposite the first end of the vessel;
an oxidant inlet through which an oxidant enters the vessel and oxidizes coke accumulated within the vessel; and
an exhaust outlet through which exhaust from oxidation of the coke exits the vessel.

2. The reactor of claim 1, further comprising a gas redistributor disposed between the first stage catalyst block and the second stage catalyst block.

3. The reactor of claim 1, further comprising a quenching zone disposed between the first stage catalyst block and the at least one electric heater.

4. The reactor of claim 1, wherein the second stage catalyst block is larger than the first stage catalyst block.

5. The reactor of claim 1, wherein the second stage catalyst block has a smaller diameter than the first stage catalyst block.

6. A process for converting C₁-C₃ alkane, the process comprising:
providing at a feed inlet of a vessel a feed comprising the C₁-C₃ alkane to a plurality of catalyst stages disposed within the vessel, the plurality of catalyst stages comprising at least a first stage catalyst block and a second stage catalyst block;
heating the C₁-C₃ alkane to produce hydrogen and liquid C₂-C₁₀ hydrocarbon product, the heating provided by an electric heater disposed between the first stage catalyst block and the second stage catalyst block;
turning off the feed of the C₁-C₃ alkane to the vessel;
providing at an oxidate inlet of the vessel a feed of an oxidate, wherein the oxidate oxidizes coke within the reactor and regenerates the plurality of the catalyst stages; and
removing at an exhaust outlet of the vessel an exhaust from oxidation of the coke within the vessel.

7. The process of claim 6, further comprising redistributing the C₁-C₃ alkane between the first stage catalyst block and the second stage catalyst block.

8. The process of claim 6, further comprising cooling the hydrogen and the liquid C₂-C₁₀ hydrocarbon product in a quenching zone between the first stage catalyst block and the second stage catalyst block.

9. The process of claim 6, wherein the second stage catalyst block is larger than the first stage catalyst block.

10. The process of claim 6, wherein the second stage catalyst block as a smaller diameter than the first stage catalyst block.

11. A reactor for production of hydrogen, the reactor comprising:
a vessel;
a plurality of catalyst blocks within the vessel, the plurality of catalyst blocks comprising at least a first catalyst block and a second catalyst block;
at least one electric heater disposed adjacent to at least one of the first catalyst block and the second catalyst block;
a feed inlet at a first end of the vessel that provides a feed comprising C₁-C₃ alkane to the plurality of catalyst blocks;
a product outlet from which hydrogen and liquid hydrocarbons exit a second end of the vessel, wherein the second end of the vessel is located opposite the first end of the vessel;
an oxidant inlet through which an oxidant enters the vessel and oxidizes coke accumulated within the vessel; and
an exhaust outlet through which exhaust from oxidation of the coke exits the vessel.

12. The reactor of claim 11, wherein the at least one electric heater passes through at least one of the first catalyst block and the second catalyst block.

13. The reactor of claim 11, wherein the at least one electric heater comprises a plurality of electric heaters passing through the first catalyst block and the second catalyst block.

14. A process for converting C₁-C₃ alkane, the process comprising:
providing at a feed inlet of a vessel a feed comprising the C₁-C₃ alkane to a plurality of catalyst blocks disposed within the vessel, the plurality of catalyst blocks comprising at least a first catalyst block and a second catalyst block;
heating the C₁-C₃ alkane to produce hydrogen and liquid C₂-C₁₀ hydrocarbon product, the heating provided by an electric heater disposed adjacent to at least one of the first catalyst block and the second catalyst block;
turning off the feed of the C₁-C₃ alkane to the vessel;
providing at an oxidate inlet of the vessel a feed of an oxidate, wherein the oxidate oxidizes coke within the reactor and regenerates the plurality of the catalyst stages; and
removing at an exhaust outlet of the vessel an exhaust from oxidation of the coke within the vessel.

15. The process of claim 14, wherein the at least one electric heater passes through at least one of the first catalyst block and the second catalyst block.

16. The process of claim 14, wherein the at least one electric heater comprises a plurality of electric heaters passing through the first catalyst block and the second catalyst block.

17. A reactor for production of hydrogen, the reactor comprising:
a vessel;
a plurality of reaction tubes within the vessel, the plurality of reaction tubes each housing at least one cracking catalyst block;
a plurality of oxidation tubes within the vessel, the plurality of oxidation tubes each housing at least one oxidation catalyst block;
at least one heater disposed within the vessel;
a feed inlet at a first end of the vessel that provides a feed comprising C₁-C₃ alkane to the plurality of reaction tubes;
a product outlet from which hydrogen and liquid hydrocarbons produced from conversion of the C₁-C₃ alkane exit the plurality of reaction tubes at a second end of the vessel, wherein the second end of the vessel is located opposite the first end of the vessel;
an oxidant inlet through which an oxidant enters the plurality of oxidation tubes, wherein heat generated from oxidation within the plurality of oxidation tubes is supplied to the plurality of reaction tubes; and
an exhaust outlet through which exhaust from oxidation within the oxidation tubes exits the vessel.

18. The reactor of claim 17, wherein the conversion of the C₁-C₃ alkane in the plurality of reaction tubes occurs simultaneously with the oxidation in the plurality of oxidation tubes.

19. A process for converting C₁-C₃ alkane, the process comprising:
providing at a feed inlet of a vessel a feed comprising the C₁-C₃ alkane to a plurality of reaction tubes within the vessel, the plurality of reaction tubes each housing at least one cracking catalyst block;
providing at an oxidate inlet of the vessel a feed of an oxidate to a plurality of oxidation tubes within the vessel, the plurality of oxidation tubes each housing at least one oxidation catalyst block;
heating the plurality of reaction tubes causing conversion of the C₁-C₃ alkane to produce hydrogen and liquid C₂-C₁₀ hydrocarbon product, the heating provided by at least one heater disposed within the vessel and by heat from oxidation occurring within the oxidation tubes;
removing the hydrogen and the liquid C₂-C₁₀ hydrocarbon product from the plurality of reaction tubes via a product outlet; and
removing at an exhaust outlet of the vessel an exhaust from the oxidation occurring within the oxidation tubes.

20. The process of claim 19, wherein the conversion of the C₁-C₃ alkane in the plurality of reaction tubes occurs simultaneously with the oxidation in the plurality of oxidation tubes.

21. A reactor for production of hydrogen, the reactor comprising:
a vessel;
a plurality of reaction tubes within the vessel, the plurality of reaction tubes each housing at least one catalyst block;
a plurality of burner nozzles disposed within the vessel and outside the plurality of reaction tubes, wherein the plurality of burner nozzles burn a fuel to supply heat to the reaction tubes;
a feed inlet at a first end of the vessel that provides a feed comprising C₁-C₃ alkane to the plurality of reaction tubes;
a product outlet from which the hydrogen and liquid hydrocarbons exit a second end of the vessel, wherein the second end of the vessel is located opposite the first end of the vessel;
an oxidant inlet through which an oxidant enters the plurality of reaction tubes and oxidizes coke accumulated within the reaction tubes; and
an exhaust outlet through which exhaust from oxidation of the coke exits the vessel.

22. The reactor of claim 21, wherein heat recovered from burner exhaust generated by the plurality of burner nozzles is recovered and used to heat the plurality of reaction tubes.

23. A process for converting C₁-C₃ alkane, the process comprising:
providing at a feed inlet of a vessel a feed comprising the C₁-C₃ alkane to a plurality of reaction tubes disposed within the vessel, wherein each reaction tube comprises at least one catalyst block;
heating the C₁-C₃ alkane to produce hydrogen and liquid C₂-C₁₀ hydrocarbon product, the heating provided by combustion at a plurality of burner nozzles disposed within the vessel;
turning off the feed of the C₁-C₃ alkane to the vessel;
providing at an oxidate inlet of the vessel a feed of an oxidate, wherein the oxidate oxidizes coke from the at least one catalyst block within each of the plurality of reaction tubes; and
removing at an exhaust outlet of the vessel an exhaust from oxidation of the coke within the vessel.
